(19) United States
(12) Patent Application Publication
(10) Pub. No.: US 2007/0081672 A1
(43) Pub. Date: Apr. 12, 2007

(54) Methods to enhance wlan security

(75) Inventors: Li Li, Shanghai (CN); Keyi Wu, Shanghai (CN); Wei Li, Shanghai (CN); Haoguang Guo, Shanghai (CN); Zhihong Luo, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/572,107

(22) PCT Filed: Aug. 25, 2004
(86) PCT No.: PCT/IB04/51556

§ 371 Date: Mar. 15, 2006

(30) Foreign Application Priority Data
Sep. 19, 2003 (CN) 03124912.4

(51) Int. Cl. H04K 1/00

(52) U.S. Cl. 380/270

(57) ABSTRACT

A method is provided for enhancing WLAN security performed by a wireless terminal, comprising steps of: reading the key stored in the ID card; requesting the wireless access point for authenticating identification according to the read key and the corresponding encryption algorithm; accessing the WLAN if the authentication succeeds. Said encryption algorithm can adopt algorithms in the network protocols, as well as customized encryption/decryption algorithms. With this method, the mandatory authentication can be performed for the wireless terminal to access WLAN, so as to avoid network insecurity caused by the entry of unauthorized wireless terminals into the network.

### FIELD OF THE INVENTION

The present invention relates generally to a method for enhancing WLAN security, and more particularly, to a method for enhancing WLAN security by using ID (identification) card.

### BACKGROUND OF THE INVENTION

WLAN is a flexible data communication system, by using radio waves to transmit and receive data. Thus it minimizes the requirement for wired connection and combines data connectivity with user mobility. Furthermore, WLAN is easy to be deployed, so it is widely used in buildings and on campus as an expansion to, or as an alternative for wired LAN.

Different from wired LAN that uses wired media to transfer signals from one point to another, WLAN uses wireless media (such as radio wave, infrared and etc) to transmit signals in form of broadcast. Hence, a wireless terminal in a WLAN can receive all signals from other wireless terminals within the coverage range of the same wireless AP (Access Point), although these signals are not targeting to it. The refore, information transferred in a WLAN may easily be intercepted by other wireless terminals not belonging to the WLAN, if no security measures are taken to safeguard the WLAN.

To settle the above security issue in WLAN, manufacturers have put forward some security methods for wireless networks to guarantee that information can be transferred securely through wireless media. A brief introduction will be given below to how wireless network security methods can ensure information's secure transmission through wireless media in WLAN, by exemplifying WEP (wireless equivalent privacy) method utilized by WLAN based on 802.11 standard.

WEP method safeguards network information by using the same encryption/decryption algorithm and the same encryption and decryption keys with two security measures, i.e.: perform ID authentication on wireless terminals to access the network and encrypt information transmitted in the wireless media.

In a WLAN based on 802.11 standard, when a user wants to access the network through a wireless terminal, ID authentication is first needed for the wireless terminal. Specifically as follows:

(a) the wireless terminal to access the network requests the wireless AP for ID authentication;

(b) the wireless AP returns the plaintext message for ID authentication to the wireless terminal after receiving the request for ID authentication;

(c) after receiving the plaintext message for ID authentication, the wireless terminal encrypts the plaintext message with the encryption algorithm and the encryption key provided by the WEP method, to get the ciphertext message for ID authentication, and transmits it to the wireless AP;

(d) after receiving the ciphertext message for ID authentication from the wireless terminal, the wireless AP decrypts the cipher text message using the decryption algorithm and decryption key provided by the WEP method, to get the plaintext message for ID authentication, and compares the decrypted plaintext message with the original plaintext message for ID authentication sent to the wireless terminal. If the two messages are matched, the wireless terminal will be permitted to access the network; otherwise, the wireless terminal will not be permitted to access the network, and the wireless terminal can be called as unauthorized wireless terminal.

After the wireless accesses the network, users can exchange data with the WLAN through the wireless terminal and the wireless AP. During data exchange process, the wireless terminal encrypts the data transmitted to the wireless AP, by using the encryption algorithm and encryption key provided by the WEP method, and decrypts the encrypted data from the wireless AP, by using the decryption algorithm and decryption key. The wireless AP performs the same operations on data from the wireless terminal and those transmitted to the wireless terminal.

Unauthorized wireless terminals are prevented to enter into the network or intercept the data transmitted through performing ID authentication on wireless terminals attempting to access the network and encrypting the data transmitted over wireless media, thus security of the network is enhanced. Of course, there are some cases when wireless terminals can enter into the network or intercept the data transmitted by cracking the encryption/decryption algorithm s or keys. However, with more intensive studies on wireless network security, security methods will adopt more and more robust encryption/decryption algorithms and encryption/decryption keys, which will make it more and more difficult for cracking the encryption/decryption algorithms and keys.

But even things going like that, security vulnerabilities still emerge frequently in WLAN caused by the users' reason, specifically as the following:

First, although wireless network security methods offer ID authentication mechanisms, some users in the WLAN may sideline the ID authentication mechanisms for wireless terminals attempting to access the network, thus unauthorized terminals may easily access the network.

Second, keys to be used by encryption/decryption algorithms are usually kept in the wireless terminal in form of plaintext, so users may carelessly leak out the key sometimes very easily.

As noted above, it is necessary to offer a method for enhancing WLAN security so that unauthorized wireless terminals can be prevented to enter the network and keys won't be leaked out easily.

### SUMMARY OF THE INVENTION

An object of the present invention is to provide a method for enhancing WLAN security, capable of performing mandatory ID authentication on wireless terminals attempting to access the WLAN to avoid network insecurity caused by the entry of unauthorized wireless terminals.

Another object of the present invention is to provide a method for enhancing WLAN security. With this method, keys are stored in ID cards independent of wireless terminals to enhance security of the keys.

A method for enhancing WLAN security according to the present invent, performed by a wireless terminal, comprises: reading the keys stored in the ID card; requesting the wireless AP for identification authentication, according to the key read and the corresponding encryption algorithm; accessing the WLAN if the ID authentication succeeds.

A method for enhancing WLAN security according to the present invent, performed by the wireless AP, comprises: processing the request for ID authentication sent by the wireless terminal, by utilizing the key corresponding to the key in the ID card used by the wireless terminal, according to the decryption algorithm corresponding to the encryption algorithm adopted by the wireless terminal; approving the wireless terminal to access the WLAN if the ID authentication succeeds.

The above encryption and decryption algorithms can adopt algorithms in existing network protocols, or customized encryption and decryption algorithms.

### BRIEF DESCRIPTION OF THE DRAWINGS

FIG. 1 is a block diagram illustrating the use of the encryption/decryption algorithms in 802.11 standards in accordance with the present invention;

FIG. 2 is a block diagram illustrating the use of customized encryption/decryption algorithms added to 802.11 standards in accordance with the present invention.

### DETAILED DESCRIPTION OF THE INVENTION

The main idea of the present invention can be summarized as: storing keys in an ID card; when a user wants to access the WLAN through a wireless terminal, he has to provide the key to the wireless terminal by using the ID card; the wireless terminal requests the wireless AP for ID authentication according to the acquired key, if ID authentication succeeds, the wireless AP approves the wireless terminal to access the network and the user can access the WLAN through the wireless terminal; otherwise, the wireless AP refuses the wireless terminal and the user can't access the WLAN through the wireless terminal.

A detailed description will be given below to the WLAN security enhancement method using ID card in accordance with the present invention, exemplifying an embodiment in which a reader attempts to access the e-library in the WLAN.

When a reader wants to download e-books from the e-library in the WLAN, the librarian provide him with an ID card in which keys are stored. The reader can insert the ID card into the WLAN card of a wireless terminal. The wireless terminal first reads keys from the ID card through its WLAN card, and requests the wireless AP for ID authentication according to the read key. If ID authentication succeeds, the wireless AP approves the wireless terminal to access the network, and thus the reader can download e-books from the e-library through the wireless terminal; otherwise, the wireless AP refuses the wireless terminal to access the network and thus the reader can't download e-books from the e-library through the wireless terminal. If the reader can download e-books from the e-library through the wireless terminal, he pulls out the ID card from the WLAN card of the wireless terminal and returns it to the librarian when leaving the e-library.

The above ID card can store keys to be used in WLAN, as well as other keys to be used for systems following other standards, such as keys for GPRS and those for 3 G systems. Users generally prefer to integrate keys for multiple standards into one single card, so keys for multiple standards can be integrated into the ID card in accordance with the present invention by referring to the GPRS SIM card used in notebook PC.

There are two cases during ID authentication using the ID card: one case is that only use the encryption/decryption algorithms in existing network protocols; the other is that use the encryption/decryption algorithms in existing network protocols and the customized encryption/decryption algorithms. Taking 802.11 standards as example, we can use the encryption/decryption algorithms in 802.11 standards only, or use the encryption/decryption algorithms in existing 802.11 standards along with the customized encryption/decryption algorithms newly added into 802.11 standards. Detailed description will be given below to the two cases.

I Only Use the Encryption/Decryption Algorithm in Existing 802.11 Standards

In this case, only the encryption/decryption algorithms in existing 802.11 standards are used for ID authentication. The same encryption/decryption algorithm in 802.11 standards is used to encrypt and decrypt the information for ID authentication, and furthermore the same key is used for encryption and decryption in the same encryption/decryption algorithm, therefore the keys in 802.11 standards should be managed very strictly in this case. For instance, the keys for use in WEP or AES are stored in the ID card, and then the ID card can be distributed to users in visible ways to avoid leakage of keys.

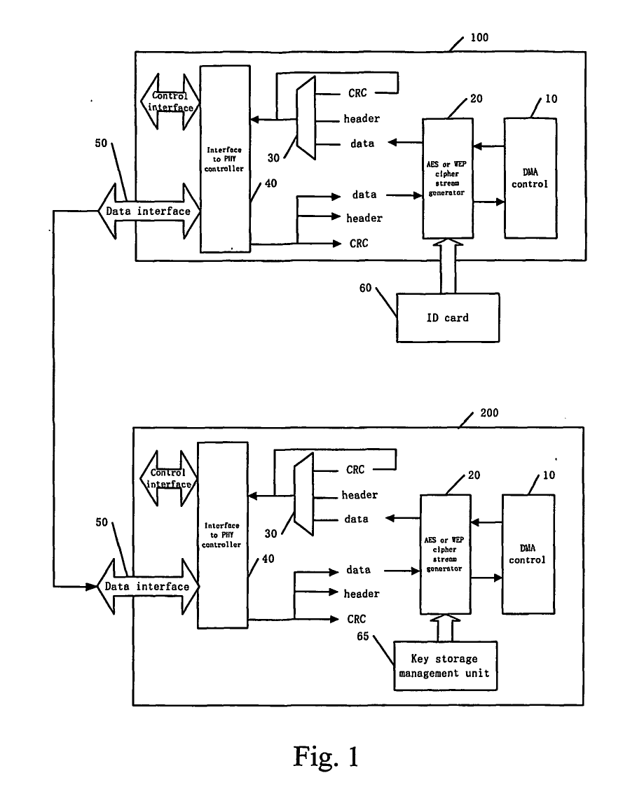

FIG. 1 is a block diagram illustrating the structure of ID authentication by only using the encryption/decryption algorithms in existing 802.11 standards and the ID card. A description will be given below to the procedure as how the wireless terminal requests the wireless AP for ID authentication, in conjunction with FIG. 1.

When wireless terminal 100 requests wireless AP 200 for ID authentication, on the receipt of the plaintext message for ID authentication from the wireless AP, Direct Memory Access (DMA) control module 10 in wireless terminal 100 acquires the plaintext message for ID authentication and sends it to AES/WEP cipher stream generator 20. After receiving the plaintext message for ID authentication, AES/WEP cipher stream generator acquires the encryption key from ID card 60, and encrypts the plaintext message with the encryption key and encryption algorithm in 802.11 standards, to get the ciphertext message for ID authentication, and then sends the ciphertext message to frame generating unit 30. On receipt of the ciphertext message for ID authentication, frame generating unit 30 synthesizes it with corresponding frame header and CRC to get the ID authentication data frame of the ciphertext, then sends the synthesized ID authentication data frame of the ciphertext to wireless AP 200 through physical layer controller interface 40 and data interface 50.

After receiving the ID authentication data frame of the ciphertext from the wireless terminal, wireless AP 200 sends the ID authentication data frame of the ciphertext containing frame header, CRC and the data frame of cipher message for ID authentication to AES/WEP cipher stream generator 20 through data interface 50 and physical layer controller interface 40.

AES/WEP cipher stream generator 20 extracts the ciphertext message for ID authentication from the received ID authentication data frame of the ciphertext, and then decrypts the ciphertext message for ID authentication with the decryption algorithm in existing 802.11 standards, according to the decryption key corresponding to the encryption key used by the wireless terminal stored in key storage management unit 65, to get the plaintext message for ID authentication, and sends it to DMA control module 10. DMA control module 10 sends the received plaintext message for ID authentication to the corresponding processing module (not shown in FIG. 1), to judge whether it accords with the original plaintext message for ID authentication sent to the wireless terminal. If yes, it indicates that ID authentication for the wireless terminal succeeds and the wireless terminal can access the WLAN; otherwise, it indicates that ID authentication for the wireless terminal fails and the wireless terminal can It access the WLAN.

II Use Encryption/Decryption Algorithms in Existing 802.11 Standards Along with Customized Encryption/Decryption Algorithms

In this case, the wireless terminal encrypts the plaintext message for ID authentication by using the encryption algorithm in existing 802.11 standards, and then encrypts it further with customized encryption algorithm. Thus, ID authentication for authorize d wireless terminals won It succeed even if they know the encryption algorithm in 802.11 standards, because the customized encryption algorithm is unknown. Accordingly, unauthorized wireless terminals are prevented to enter the WLAN.

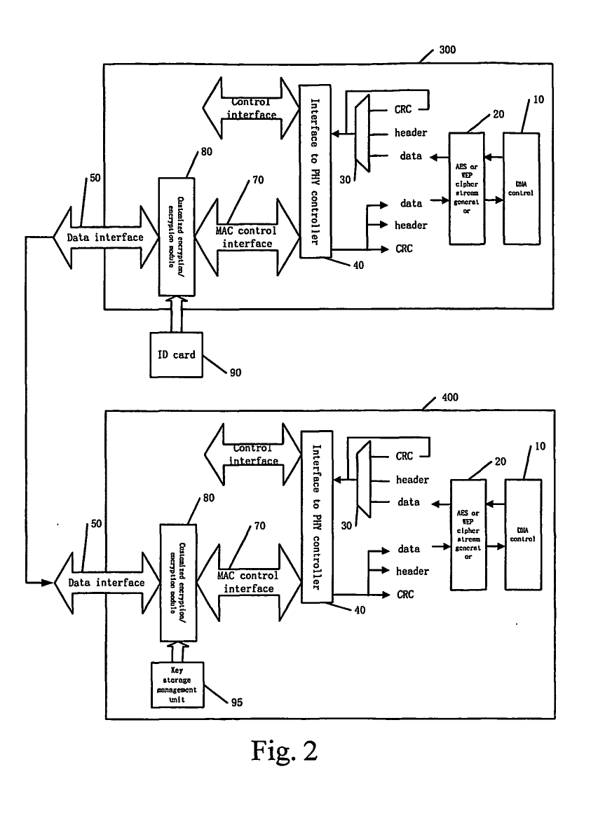

FIG. 2 displays the block diagram in which customized encryption/decryption algorithms are added into 802.11 standards. As shown in the figure, the customized encryption/decryption module 80 is added into existing WLAN to implement the customized algorithms such as RSA, DES, DSA, MD5 or other new algorithms, and the keys for the customized encryption/decryption algorithms are stored in ID card 90. It can be seen from FIG. 2 that the customized encryption/decryption algorithms can be easily added into 802.11 standards through ID card, without making modifications to any high-level protocol in WLAN.

A detailed description will go below to the procedure as how WLAN uses encryption/decryption algorithms in 802.11 existing standards and the customized encryption/decryption algorithms f or ID authentication, in conjunction with the structure as shown in FIG. 2.

When wireless terminal 300 requests AP 400 for ID authentication, the wireless AP first sends the plaintext message for ID authentication to the wireless terminal.

On receipt of the plaintext message for ID authentication from the wireless AP, DMA control module 10 in the wireless terminal acquires the plaintext message for ID authentication and sends it to AES/WEP cipher stream generator 20. After obtaining the plaintext message for ID authentication, AES/WEP cipher stream generator 20 encrypts it by using the encryption algorithm in 802.11 standards and corresponding encryption key, to get the preliminary encryption message for ID authentication, and sends it to frame generating un it 30. Frame generating unit 30 synthesizes the preliminary encryption message for ID authentication and the corresponding frame header and CRC into the preliminary encrypted ID authentication frame, and sends it to customized encryption/decryption module 80 through physical layer controller interface 40 and MAC layer data interface 70. Customized encryption/decryption module 80 further encrypts the received preliminary encrypted ID authentication frame by using customized encryption algorithm according to the encryption key obtained from ID card 90, to get the ID authentication frame of the ciphertext, and sends it to data interface 50. In the end, data interface 50 sends the ID authentication frame of the ciphertext to wireless AP.

On receipt of the ID authentication frame of the ciphertext sent by the wireless terminal via data interface 50, the wireless AP sends it to customized encryption/decryption module 80. Customized encryption/decryption module 80 uses customized decryption algorithm to decrypt the received ID authentication frame of the ciphertext according to the decryption key stored in key storage management unit 95 and corresponding to the encryption key used by the customized encryption algorithm of the wireless terminal, to get the preliminary decrypted ID authentication frame (including frame header, CRC and the preliminary ciphertext message for ID authentication), and sends it to AES/WEP cipher stream generator 20 through MAC layer data interface 70 and physical layer controller interface 40. AES/WEP cipher stream generator 20 extracts the preliminary ciphertext message for ID authentication from the received 15 preliminary decrypted ID authentication frame, then further decrypts the message by using the decryption algorithm in 802.11 standards and the corresponding decryption key, to get the plaintext message for ID authentication, and sends the plaintext message for ID authentication to DMA control module 10. DMA control module 10 sends the plaintext message for ID authentication to the corresponding processing module (not displayed in FIG. 2) to judge whether it accords with the original plaintext message for ID authentication sent to the wireless terminal. If yes, it indicates that ID authentication for the wireless terminal succeeds and the wireless can access the WLAN; otherwise, it indicates that ID authentication for the wireless terminal fails and the wireless terminal can it access the WLAN.

Beneficial Results of the Invention

As described above, with regard to the WLAN security enhancement method as provided in the present invention, keys are stored in ID card to enhance security of the keys, and meanwhile wireless terminals attempting to access the WLAN need pass mandatory ID authentication, thus network insecurity caused by the entry of unauthorized wireless terminals can be avoided.

It is to be understood by those skilled in the art that the method for enhancing WLAN security as disclosed in this invention can be modified considerably without departing from the spirit and scope of the in vention as defined by the appended claims.

What is claimed is:

1. A method for enhancing WLAN security performed by a wireless terminal, comprising steps of:
(a) reading the key stored in the ID card;
(b) requesting the wireless access point for processing identification authentication, according to the re ad key and the corresponding encryption algorithm;
(c) accessing the WLAN if the identification authentication succeeds.

2. The method of claim 1, wherein step (b) further includes:
requesting the wireless access point for processing identification authentication according to the read key and the encryption algorithm in LAN protocols.

3. The method of claim 1, wherein step (b) further includes:
requesting the wireless access point for processing identification authentication according to the read key and the cu stomized encryption algorithm.

4. The method of claim 1, wherein step (b) further includes:
requesting the wireless access point for processing identification authentication according to the read key and the encryption algorithm in LAN protocols and the cu stomized encryption algorithm.

5. A wireless terminal in WLAN, comprising:
an information reading unit, for reading the key stored in the ID card;
an identification authenticating unit, for requesting the wireless access point for authenticating identification according to the read key and the corresponding encryption algorithm;
a network accessing unit, for accessing the WLAN if the identification authentication succeeds.

6. The wireless terminal in claim 5, wherein said encryption algorithm can be the encryption algorithm in LAN protocols.

7. The wireless terminal in claim 5, wherein said encryption algorithm can be the customized encryption algorithm.

8. The wireless terminal in claim 5, wherein said encryption algorithm can be the encryption algorithm in LAN protocols and the customized encryption algorithm.

9. A method for enhancing WLAN security performed by the wireless access point, comprising:
processing the request for authenticating identification initialized by the wireless terminal, by utilizing the key corresponding to the key in the ID card used by the wireless terminal, according to the decryption algorithm corresponding to the encryption algorithm adopted by the wireless terminal;
permitting the wireless terminal to access the WLAN if the identification authentication succeeds.

10. The method in claim 9, wherein said decryption algorithm can be the decryption algorithm in LAN protocols.

11. The method in claim 9, wherein said decryption algorithm can be the customized decryption algorithm.

12. The method in claim 9, wherein said decryption algorithm can be the decryption algorithm in LAN protocols and the customized decryption algorithm.

13. An access point in WLAN, comprising:
a key storage management unit, for storing valid keys;
an identification authentication processing unit, for reading the key corresponding to the key in the ID card used by the wireless terminal from the key storage management unit, and using said corresponding key to process the request for authenticating identification initialized by the wireless terminal according to the decryption algorithm corresponding to the encryption algorithm adopted by the wireless terminal;
a network accessing unit, for permitting the wireless terminal to access the WLAN when the identification authentication succeeds.

14. A method for enhancing WLAN security, comprising steps of:
acquiring an ID card stored with keys of a wireless terminal;
sending a request for accessing a WLAN to a wireless access point;
authenticating the identification by utilizing the key in the ID card and the information for authenticating identification according to the encryption algorithm in the wireless terminal and the corresponding decryption algorithm in the wireless access point;
accessing the resources in the WLAN via the wireless access point after the identification authentication succeeds.
